(19) United States
(12) Patent Application Publication
(10) Pub. No.: US 2025/0218640 A1
(43) Pub. Date: Jul. 3, 2025

(54) MULTILAYER COIL COMPONENT

(71) Applicant: Murata Manufacturing Co., Ltd., Kyoto-fu (JP)

(72) Inventors: Akinori HATTORI, Nagaokakyo-shi (JP); Rika YAMADA, Nagaokakyo-shi (JP); Katsuhisa IMADA, Nagaokakyo-shi (JP); Keita ASAI, Nagaokakyo-shi (JP)

(73) Assignee: Murata Manufacturing Co., Ltd., Kyoto-fu (JP)

(21) Appl. No.: 19/002,332

(22) Filed: Dec. 26, 2024

(30) Foreign Application Priority Data
Dec. 28, 2023 (JP) 2023-222450
Sep. 25, 2024 (JP) 2024-166220

(51) Int. Cl. H01F 17/00

(52) U.S. Cl. CPC H01F 17/0013; H01F 2017/002

(57) ABSTRACT

A multilayer coil component includes a multilayer body formed by laminating a plurality of insulating layers and having a coil therein; and first and second outer electrodes electrically connected to the coil. The coil is formed by electrically connecting a plurality of coil conductors laminated together with the insulating layers, with a via conductor passing through the insulating layers therebetween. The coil conductors each include a circumferential portion and a land connected to the via conductor. The multilayer body has first and second end surfaces facing each other in a length direction, first and second principal surfaces facing each other in a height direction orthogonal to the length direction, and first and second side surfaces facing each other in a width direction orthogonal to the length and height directions. A coil axis of the coil is parallel to the first principal surface.

### CROSS-REFERENCE TO RELATED APPLICATIONS

This application claims benefit of priority to Japanese Patent Application No. 2024-166220, filed Sep. 25, 2024, and to Japanese Patent Application No. 2023-222450, filed Dec. 28, 2023, the entire content of each are incorporated herein by reference.

### BACKGROUND

### Technical Field

The present disclosure relates to a multilayer coil component.

### Background Art

Japanese Unexamined Patent Application Publication No. 2002-15918 describes a multilayer electronic component that includes coil conductors and insulating layers made of a magnetic material or a non-magnetic material laminated to form a coil therein. The multilayer electronic component includes terminal electrodes at both end portions thereof in the lamination direction. The terminal electrode at at least one end is connected to an end portion of the coil inside a multilayer body, with a conductor-filled through hole provided in at least one insulating layer and an extended electrode covering the end portion of the through hole therebetween. The multilayer electronic component is characterized in that the area of the extended electrode is set to greater than or equal to three times the cross-sectional area of the through hole and less than or equal to one-third of the inner area of the coil when the multilayer body is viewed through in the lamination direction.

### SUMMARY

A multilayer coil component in which a coil is disposed with the coil axis thereof parallel to the mounting surface (hereinafter also referred to as a horizontally-wound multilayer inductor), such as the multilayer electronic component described in Japanese Unexamined Patent Application Publication No. 2002-15918, has a structure that is suitable for high-frequency application. In a conventional horizontally-wound multilayer inductor, where an insulating layer between coil conductors is made of ferrite with a dielectric constant of about 15, stray capacitance affects high-frequency characteristics of the inductor. Particularly in recent years when improved high-frequency characteristics have been required, stray capacitance between adjacent coil conductors has been an obstacle to improving high-frequency characteristics.

Accordingly, the present disclosure provides a multilayer coil component having good high-frequency characteristics.

A multilayer coil component according to the present disclosure includes a multilayer body formed by laminating a plurality of insulating layers, the multilayer body having a coil therein; and a first outer electrode and a second outer electrode electrically connected to the coil. The coil is formed by electrically connecting a plurality of coil conductors laminated together with the insulating layers, with a via conductor passing through the insulating layers therebetween. The coil conductors each include a circumferential portion and a land connected to the via conductor. The multilayer body has a first end surface and a second end surface facing each other in a length direction, a first principal surface and a second principal surface facing each other in a height direction orthogonal to the length direction, and a first side surface and a second side surface facing each other in a width direction orthogonal to the length direction and the height direction. A coil axis of the coil is parallel to the first principal surface. The coil conductors each have a first surface facing in a first direction parallel to the coil axis and a second surface facing in a direction opposite the first direction. The circumferential portion of at least one of the coil conductors is provided with a first cavity only between the first surface thereof and the insulating layer.

The present disclosure can provide a multilayer coil component having good high-frequency characteristics.

### BRIEF DESCRIPTION OF THE DRAWINGS

FIG. 1 is a perspective view schematically illustrating an example of a multilayer coil component according to the present disclosure;

FIG. 2 is an exploded perspective view schematically illustrating an example of a multilayer body constituting the multilayer coil component illustrated in FIG. 1;

FIG. 3 is a transparent side view schematically illustrating an example of an internal structure of the multilayer body constituting the multilayer coil component illustrated in FIG. 1;

FIG. 4 is a cross-sectional view schematically illustrating an example of a cross-section taken along line segment A1-A1 in the multilayer coil component illustrated in FIG. 1;

FIG. 5 is a graph showing frequency characteristics of impedance of Example 1 and Comparative Example 1;

FIG. 6 is an enlarged schematic cross-sectional view of the vicinity of coil conductors illustrated in FIG. 4;

FIG. 7 is a transparent view schematically illustrating an example of an internal structure of the multilayer body constituting the multilayer coil component illustrated in FIG. 1, as viewed from a second end surface of the multilayer body;

FIG. 8 is a cross-sectional view schematically illustrating an example of a cross-section taken along line segment A1-A1 in the multilayer coil component illustrated in FIG. 7;

FIG. 9 is an exploded perspective view schematically illustrating another example of the multilayer body constituting the multilayer coil component illustrated in FIG. 1; and

FIG. 10 schematically illustrates a test method for verifying the amount of side gap.

### DETAILED DESCRIPTION

A multilayer coil component according to the present disclosure will now be described. Note that the present disclosure is not limited to configurations described below, and may be changed as appropriate without departing from the gist of the present disclosure. The present disclosure also includes combinations of preferred configurations described below.

The drawings to be described below are schematic illustrations, and dimensions, scales of aspect ratios, and the like may differ from those of actual products. In the drawings, the same reference numerals are used for the same or equivalent parts. The same elements in the drawings are given the same reference numerals to omit redundant descriptions.

In the present specification, the terms indicating relations between elements (e.g., “parallel”, “orthogonal”, etc.) and the terms indicating shapes of elements are used not only in their literal, strict senses, but also in substantially the same senses, such as those including differences on the order of several percent.

Embodiments described below are examples and configurations described in different embodiments may be partially replaced or combined. In the second embodiments and other embodiments that follow, the description of matters that are common to the first embodiment will be omitted and differences alone will be described. In particular, the same operations and effects achieved by the same configurations will not be mentioned for every embodiment.

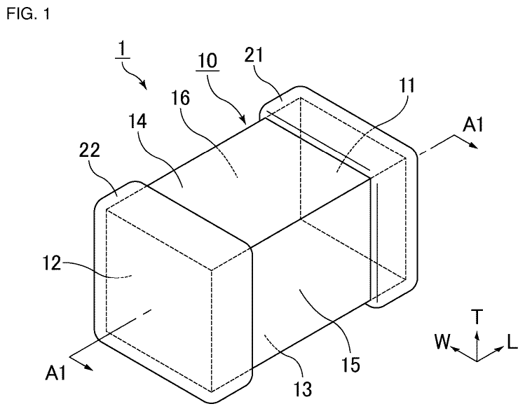

FIG. 1 is a perspective view schematically illustrating an example of a multilayer coil component according to the present disclosure.

A multilayer coil component 1 illustrated in FIG. 1 includes a multilayer body (element body) 10, and a first outer electrode 21 and a second outer electrode 22 disposed on an outer surface of the multilayer body 10. The multilayer body 10 is in the shape of a rectangular parallelepiped having six surfaces. As will be described below, the multilayer body 10 is configured by laminating a plurality of insulating layers and a plurality of coil conductors in a lamination direction and has a coil therein. The first outer electrode 21 and the second outer electrode 22 are individually electrically connected to the coil.

In the multilayer coil component and the multilayer body in the present specification, a length direction, a height direction, and a width direction are an L direction, a T direction, and a W direction, respectively, in FIG. 1. The length direction L, the height direction T, and the width direction W are orthogonal to each other. Here, the length direction Lis a direction parallel to the lamination direction.

As illustrated in FIG. 1, the multilayer body 10 has a first end surface 11 and a second end surface 12 facing each other in the length direction L, a first principal surface 13 and a second principal surface 14 facing each other in the height direction T orthogonal to the length direction L, and a first side surface 15 and a second side surface 16 facing each other in the width direction W orthogonal to the length direction L and the height direction T.

Although not illustrated in FIG. 1, the multilayer body 10 is preferably rounded at corners and ridges thereof. A corner is a portion where three surfaces of the multilayer body meet, and a ridge is a portion where two surfaces of the multilayer body meet.

The first outer electrode 21 covers, for example as illustrated in FIG. 1, the entire first end surface 11 of the multilayer body 10 and extends from the first end surface 11 to cover part of the first principal surface 13, part of the second principal surface 14, part of the first side surface 15, and part of the second side surface 16.

The second outer electrode 22 covers, for example as illustrated in FIG. 1, the entire second end surface 12 of the multilayer body 10 and extends from the second end surface 12 to cover part of the first principal surface 13, part of the second principal surface 14, part of the first side surface 15, and part of the second side surface 16.

When the multilayer coil component 1, including the first outer electrode 21 and the second outer electrode 22 arranged as described above, is to be mounted on a substrate, one of the first principal surface 13, the second principal surface 14, the first side surface 15, and the second side surface 16 of the multilayer body 10 serves as a mounting surface.

The first outer electrode 21 is simply required to extend from at least part of the first end surface 11 of the multilayer body 10 to the mounting surface of the multilayer body 10.

Similarly, the second outer electrode 22 is simply required to extend from at least part of the second end surface 12 of the multilayer body 10 to the mounting surface of the multilayer body 10.

The first outer electrode 21 and the second outer electrode 22 may each have either a single-layered structure or a multi-layered structure.

When the first outer electrode 21 and the second outer electrode 22 each have a single-layered structure, the constituent material of the outer electrode is, for example, Ag, Au, Cu, Pd, Ni, Al, or an alloy containing at least one of these metals.

When the first outer electrode 21 and the second outer electrode 22 each have a multi-layered structure, the outer electrode may include, for example, a base electrode layer containing Ag, a Ni coating, and a Sn coating in order from the surface side of the multilayer body 10.

The size of the multilayer coil component according to the present disclosure is not particularly limited, but it is preferably size 1608, size 0603, size 0402, or size 1005.

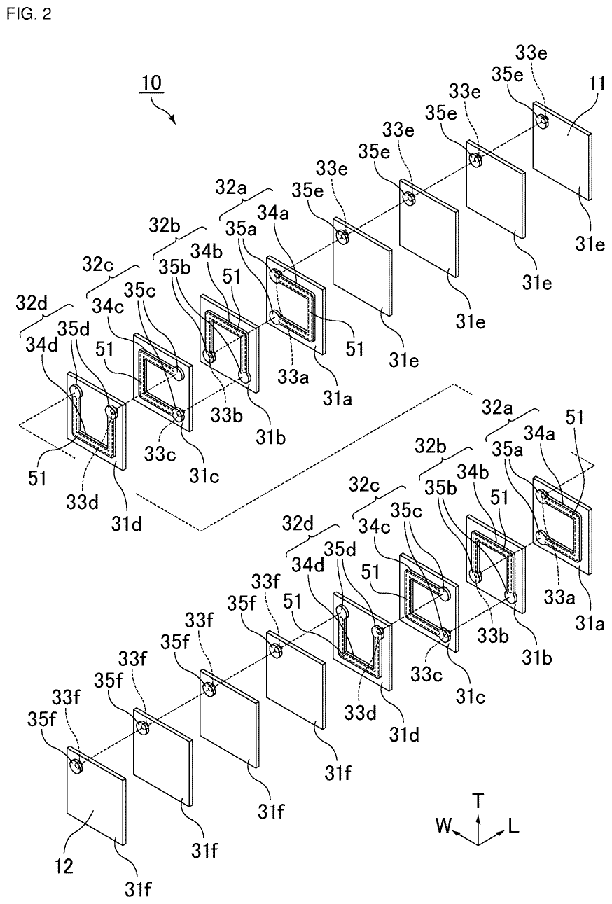

FIG. 2 is an exploded perspective view schematically illustrating an example of a multilayer body constituting the multilayer coil component illustrated in FIG. 1.

As illustrated in FIG. 2, the multilayer body 10 is configured by laminating a plurality of insulating layers 31a, 31b, 31c, 31d, 31e, and 31f from the first end surface 11 toward the second end surface 12 of the multilayer body 10 in the lamination direction (or the length direction L here). Hereinafter, the insulating layers 31a, 31b, 31c, 31d, 3l, and 31f may be collectively referred to as insulating layers 31.

In the present specification, a direction in which the plurality of insulating layers constituting the multilayer body are laminated is referred to as a lamination direction.

In FIG. 2, the insulating layers 31e are arranged on the lower side in the lamination direction (or on the side of the first end surface 11 of the multilayer body 10), and the insulating layers 31f are arranged on the upper side in the lamination direction (or on the side of the second end surface 12 of the multilayer body 10).

The constituent material of each insulating layer 31 is, for example, a magnetic material, such as a ferrite material.

The insulating layers 31a, 31b, 31c, and 31d are provided with coil conductors 32a, 32b, 32c, and 32d, respectively, and via conductors 33a, 33b, 33c, and 33d, respectively. The insulating layers 31e are each provided with a via conductor 33e and a land 35e. The insulating layers 31f are each provided with a via conductor 33f and a land 35f. There may be one insulating layer 31e, or may be two or more insulating layers 31e. Similarly, there may be one insulating layer 31f, or may be two or more insulating layers 31f. Hereinafter, the coil conductors 32a, 32b, 32c, and 32d may be collectively referred to as coil conductors 32.

The coil conductors 32a, 32b, 32c, and 32d are disposed on respective principal surfaces of the insulating layers 31a, 31b, 31c, and 31d and laminated together with the insulating layers 31a, 31b, 31c, 31d, 31e, and 31f. In FIG. 2, the coil conductors 32 each have a ¾ turn shape and are repeatedly laminated, with four insulating layers 31 arranged in the order of insulating layers 31a, 31b, 31c, and 31d as one unit (three turns).

The coil conductors 32a, 32b, 32c, and 32d include annular circumferential portions 34a, 34b, 34c, and 34d, respectively, each being partially missing and leaving a gap, and lands 35a, 35b, 35c, and 35d, respectively. The circumferential portions 34a, 34b, 34c, and 34d are provided with the lands 35a, 35b, 35c, and 35d, respectively, at both end portions thereof. Hereinafter, the circumferential portions 34a, 34b, 34c, and 34d may be collectively referred to as circumferential portions 34.

The via conductors 33a, 33b, 33c, 33d, 33e, and 33f are provided so as to pass through the insulating layers 31a, 31b, 31c, 31d, 31e, and 31f, respectively, in the lamination direction. Hereinafter, the via conductors 33a, 33b, 33c, 33d, 33e, and 33f may be collectively referred to as via conductors 33.

The lands 35e and 35f are disposed directly on the via conductors 33e and 33f, respectively. The lands 35a, 35b, 35c, 35d, 35e, and 35f are preferably slightly greater than the line width of the circumferential portions 34a, 34b, 34c, and 34d. Hereinafter, the lands 35a, 35b, 35c, 35d, 35e, and 35f may be collectively referred to as lands 35. The lands 35 are greater than the via conductors 33 adjacent thereto. When viewed in the lamination direction (length direction L), the via conductor 33 adjacent to each land 35 is within the region of the land 35.

The constituent material of the coil conductors 32, each including the circumferential portion 34 and the lands 35, and the via conductors 33 is, for example, Ag, Au, Cu, Pd, Ni, Al, or an alloy containing at least one of these metals.

The plurality of insulating layers 31a, 31b, 31c, 31d, 31e, and 31f configured as described above are laminated in the lamination direction. The multilayer body 10 is thus produced, and the plurality of coil conductors 32a, 32b, 32c, and 32d are electrically connected, with the via conductors 33a, 33b, 33c, and 33d therebetween. This produces, in the multilayer body 10, a solenoid coil having a coil axis parallel to the lamination direction.

The via conductors 33e and the lands 35e form a first extended conductor inside the multilayer body 10 and are exposed to the first end surface 11 of the multilayer body 10. That is, the first extended conductor includes the via conductors 33e and the lands 35e. As described below, in the multilayer body 10, the first extended conductor connects the first outer electrode 21 to the coil conductor 32a facing the first outer electrode 21.

The via conductors 33f and the lands 35f form a second extended conductor inside the multilayer body 10 and are exposed to the second end surface 12 of the multilayer body 10. That is, the second extended conductor includes the via conductors 33f and the lands 35f. As described below, in the multilayer body 10, the second extended conductor connects the second outer electrode 22 to the coil conductor 32d facing the second outer electrode 22.

The coil conductors 32 preferably overlap each other when viewed in the lamination direction (length direction L). When viewed in the lamination direction, the coil may have a shape composed of straight portions, such as those illustrated in FIG. 2 (e.g., a polygonal shape, such as a rectangular shape), a shape composed of curved portions (e.g., a circular shape), or a shape composed of straight and curved portions.

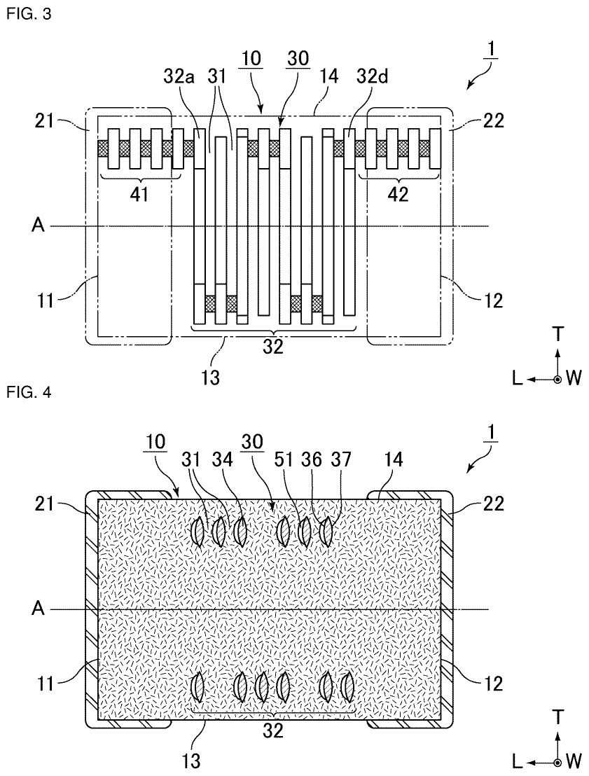

FIG. 3 is a transparent side view schematically illustrating an example of an internal structure of the multilayer body constituting the multilayer coil component illustrated in FIG. 1.

As illustrated in FIG. 3, in the multilayer coil component 1, where the plurality of insulating layers 31 are laminated in the length direction L, the length direction L is the lamination direction. The lamination direction of the multilayer body 10 and a coil axis A of a coil 30 are parallel to one of the first principal surface 13, the second principal surface 14, the first side surface 15, and the second side surface 16, serving as the mounting surface. For example, the lamination direction and the coil axis A are parallel to the first principal surface 13. That is, the multilayer coil component 1 is a horizontally-wound multilayer inductor in which the coil 30 is disposed, with the coil axis A parallel to the mounting surface.

As illustrated in FIG. 3, actually, no boundaries are visually recognized between adjacent insulating layers 31.

A first extended conductor 41 extends in the lamination direction inside the multilayer body 10 and linearly connects the first outer electrode 21 on the first end surface 11 to the coil conductor 32a facing the first outer electrode 21. Similarly, a second extended conductor 42 extends in the lamination direction inside the multilayer body 10 and linearly connects the second outer electrode 22 on the second end surface 12 to the coil conductor 32d facing the second outer electrode 22.

When viewed in the lamination direction (length direction L), the via conductors constituting each extended conductor preferably overlap each other. However, the via conductors constituting each extended conductor are not necessarily required to be arranged exactly in a straight line.

FIG. 2 and FIG. 3 illustrate an example in which the number of coil conductors 32 laminated to form three turns of the coil 30 is four; that is, the repeating shape of the coil conductors 32 is a ¾ turn shape. However, the number of coil conductors 32 laminated to form one turn of the coil 30 is not particularly limited. For example, the number of coil conductors 32 laminated to form one turn of the coil 30 may be two; that is, the repeating shape may be a ½ turn shape.

The number of coil conductors 32 laminated, that is, the number of all the coil conductors 32 laminated in the multilayer body 10, is not particularly limited, and may be greater than or equal to 8 and less than or equal to 32 (i.e., from 8 to 32).

FIG. 4 is a cross-sectional view schematically illustrating an example of a cross-section taken along line segment A1-A1 in the multilayer coil component illustrated in FIG. 1. Note that FIG. 4 illustrates a cross-section of the circumferential portions 34 of the coil conductors 32.

As illustrated in FIG. 4, in a cross-section perpendicular to the direction in which the coil conductors 32 extend, the cross-sectional shape of the coil conductors 32 is a flat shape (longitudinal shape) and its longitudinal direction is orthogonal to the lamination direction (length direction L). In the example illustrated in FIG. 4, the cross-sectional shape of the coil conductors 32 is an elliptical shape whose major axis is orthogonal to the lamination direction. However, the cross-sectional shape of the coil conductors 32 is not particularly limited and may be, for example, a rectangular shape whose sides forming a pair and opposite each other in the lamination direction have the same length, or a trapezoidal shape whose sides forming a pair and opposite each other in the lamination direction have different lengths.

As illustrated in FIG. 4, the coil conductors 32 each have a first surface 36 facing in a first direction parallel to the coil axis A and a second surface 37 facing in a direction opposite the first direction. The first surface 36 and the second surface 37 both extend in a direction orthogonal to the lamination direction.

The circumferential portion 34 of each coil conductor 32 is provided with a first cavity 51 only between the first surface 36 and the insulating layer 31. The first cavity 51 can reduce stray capacitance between adjacent coil conductors 32. Generally, horizontally-wound multilayer inductors have lower stray capacitance than multilayer coil components in which the coil is disposed with the coil axis perpendicular to the mounting surface. By providing air having a lower dielectric constant than the insulating layer 31 (e.g., ferrite material) inside the multilayer body 10, as in the present embodiment, stray capacitance can be further reduced. This can further improve high-frequency characteristics. In the present embodiment, therefore, the high-frequency characteristics of the multilayer coil component 1, which is a horizontally-wound multilayer inductor, can be further improved. In view of improving high-frequency characteristics, a cavity is preferably provided on one surface of the circumferential portion 34 of every coil conductor 32. However, it is simply required to provide a cavity on one surface of the circumferential portion 34 of at least one coil conductor 32. The cavity may be interrupted in the middle, but is preferably provided over the entire one surface (i.e., over the entire region of the one surface) of the coil conductor 32 in view of improving high-frequency characteristics.

If each coil conductor 32 has cavities on both sides of the first surface 36 and the second surface 37, a bending strength when the multilayer coil component 1 is mounted decreases and this leads to lower resistance to impact. Also, when such a multilayer coil component is produced by a manufacturing method described below, applying a coil conductor pattern may need to be followed by applying a resin paste, and this may make the manufacture difficult. In the multilayer coil component 1, on the other hand, the circumferential portion 34 of each coil conductor 32 is provided with the first cavity 51 only between the first surface 36 and the insulating layer 31, and provided with no cavity between the second surface 37 and the insulating layer 31, and between the insulating layer 31 and each of the side surfaces of the circumferential portion 34 (i.e., surfaces of the circumferential portion 34 on the inner and outer sides thereof). This can reduce a decrease in the bending strength when the multilayer coil component 1 is mounted. Also, the multilayer coil component 1 can be easily manufactured by the method described below.

It is simply required that a cavity be provided on only one surface of the circumferential portion 34 of each coil conductor 32, that is, only between the first surface 36 or the second surface 37 and the insulating layer 31. Of all the coil conductors 32 each being provided with a cavity on the circumferential portion 34, some of the coil conductors 32 may each be provided with the first cavity 51 only between the first surface 36 of the circumferential portion 34 and the insulating layer 31 and the remaining coil conductors 32 may each be provided with the first cavity 51 only between the second surface 37 of the circumferential portion 34 and the insulating layer 31.

In the present specification, the inner side of the coil conductor (circumferential portion) refers to one side thereof adjacent to the coil axis of the coil, and the outer side of the coil conductor refers to the other side thereof (i.e., the outer side of the coil) opposite the one side.

Here, results of simulation of electrical characteristics of the multilayer coil component 1 according to the present embodiment will be described. As Example 1 of the multilayer coil component 1 according to the present embodiment, a model corresponding to the multilayer coil component of size 1608 was used. The dimensions of a multilayer body of this model are 1.555 mm, 0.759 mm, and 0.759 mm in the length direction L, the width direction W, and the height direction T, respectively. Each first cavity is 5 μm thick, and each coil conductor is 33 μm thick. As Comparative Example 1 for the multilayer coil component 1 according to the present embodiment, the same model as above, except for the absence of a first cavity, was used.

The results were that stray capacitance in Example 1 was 0.32 pF, and stray capacitance in Comparative Example 1 was 0.48 pF. This indicates that the present embodiment can further reduce stray capacitance.

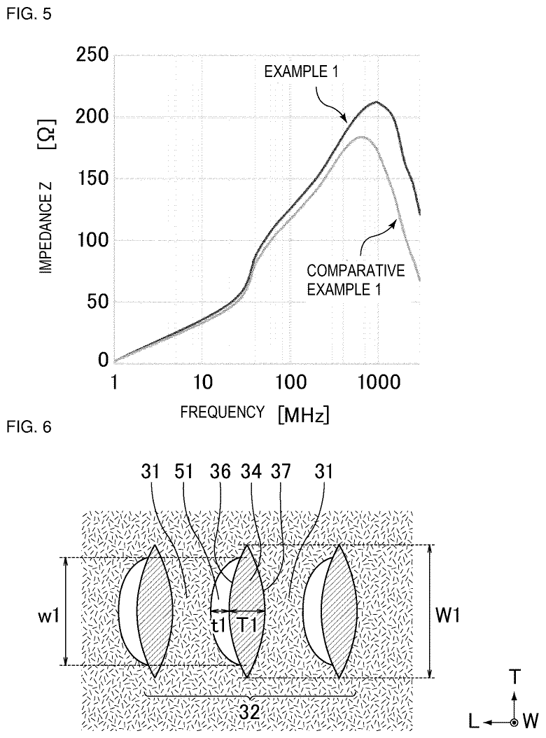

FIG. 5 is a graph showing frequency characteristics of impedance of Example 1 and Comparative Example 1.

As in FIG. 5, the peak value of impedance in Example 1 was 210 $2 at a frequency of 1000 MHz (=1 GHZ), and the peak value of impedance in Comparative Example 1 was 180 Ω at a frequency of 700 MHz. That is, Example 1 supported higher frequencies than Comparative Example 1. Also, Example 1 maintained high impedance even at frequencies of 1000 MHz and above. This means that the present embodiment can support higher frequencies.

FIG. 6 is an enlarged schematic cross-sectional view of the vicinity of coil conductors illustrated in FIG. 4.

As illustrated in FIG. 6, a width w1 of the first cavity 51 is preferably smaller than a width (line width) W1 of the circumferential portion 34. Thus, by providing the first cavity 51 only inside each coil conductor 32, a highly reliable structure can be achieved in which the insulating layers 31 (e.g., ferrite layers) are less likely to crack. Specifically, the width w1 of the first cavity 51 may be in the range from 60% to 90% of the width W1 of the circumferential portion 34. The width w1 of the first cavity 51 and the width W1 of the circumferential portion 34 compared here are the dimensions of the first cavity 51 and the circumferential portion 34 in the height direction T, in an LT cross-section passing through the coil axis. The LT cross-section passing through the coil axis is a plane parallel to the length direction L and the height direction T of the multilayer body 10, and is a cross-section cut to pass through the coil axis. The cross-section cut to pass through the coil axis refers to a cross-section where the coil axis and the cut surface are in the same plane.

As illustrated in FIG. 6, a thickness T1 of the circumferential portion 34 may be greater than or equal to 5 μm and less than or equal to 45 μm (i.e., from 5 μm to 45 μm). A thickness t1 of the first cavity 51 may be greater than or equal to 1 μm and less than or equal to 15 μm (i.e., from 1 μm to 15 μm), or may be greater than or equal to 2 μm and less than or equal to 5 μm (i.e., from 2 μm to 5 μm). If the first cavity 51 is made too large, the thickness of the circumferential portion 34 will be limited, and it may not be possible to provide a low-resistance multilayer coil component. By keeping the thickness t1 of the first cavity 51 thin in the range described above, a low-resistance multilayer coil component having good high-frequency characteristics can be provided. Specifically, by setting the thickness t1 of the first cavity 51 to greater than or equal to 1 μm, high-frequency characteristics of the multilayer coil component 1 can be more reliably improved, and can be further improved by setting the thickness t1 to greater than or equal to 2 μm. By setting the thickness t1 of the first cavity 51 to less than or equal to 15 μm, the resistance of the multilayer coil component 1 can be reduced, and can be further reduced by setting the thickness t1 to less than or equal to 5 μm.

The thicknesses t1 and T1 compared here are both measured in the center of the circumferential portion 34 in the line-width direction, in the LT cross-section passing through the coil axis.

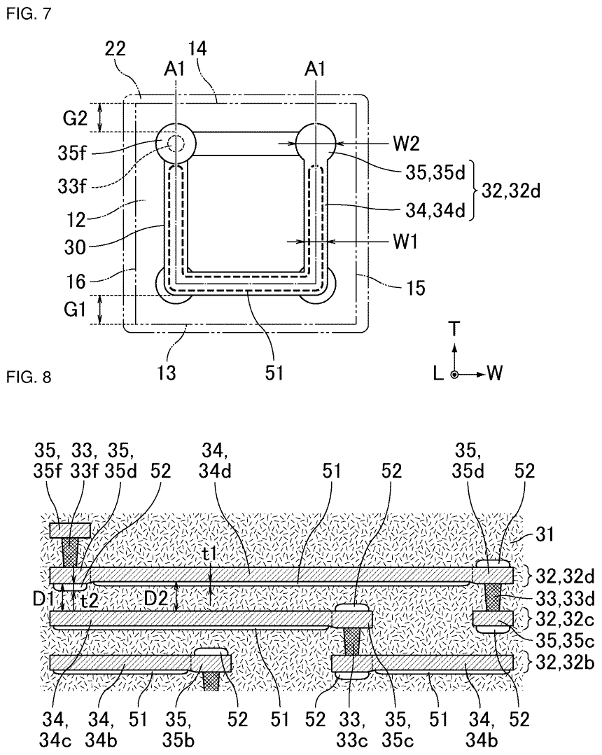

FIG. 7 is a transparent view schematically illustrating an example of an internal structure of the multilayer body constituting the multilayer coil component illustrated in FIG. 1, as viewed from the second end surface of the multilayer body. FIG. 8 is a cross-sectional view schematically illustrating an example of a cross-section taken along line segment A1-A1 in the multilayer coil component illustrated in FIG. 7.

As illustrated in FIG. 7, a width W2 of the land 35 is preferably greater than the width W1 of the circumferential portion 34. The width W2 of the land 35 is a dimension in the line-width direction of the circumferential portion 34. As illustrated in FIG. 8, the land 35 of the coil conductor 32 having the first cavity 51 thereon is provided with a second cavity 52 between the surface thereof to which the via conductor 33 is not connected and the insulating layer 31. The second cavity 52 is preferably thicker than the first cavity 51 (i.e., thickness t2 of second cavity 52>thickness t1 of first cavity 51). The thickness t1 of the first cavity 51 that is compared to the thickness t2 of the second cavity 52 here is measured in the center of the circumferential portion 34 in the line-width direction, in the LT cross-section passing through the coil axis. The thickness t2 of the second cavity 52 that is compared to the thickness t1 of the first cavity 51 is measured in the center of the land 35 in the line-width direction, in an LT cross-section passing through the center of the land 35. Thus, by providing a thicker cavity as described above, stray capacitance can be further reduced and high-frequency characteristics of the multilayer coil component 1 can be further improved. With the width W2 of the land 35 greater than the width W1 of the circumferential portion 34, the surface area of the land 35 can be increased. The second cavity 52 thicker than the first cavity 51 can thus be easily produced.

As illustrated in FIG. 2 and FIG. 7, the first cavity 51 may be provided between the first surface of the entire circumferential portion 34 and the insulating layer 31.

With reference to FIG. 7, the occurrence of cracks originating from the first cavity, inside the element body of the multilayer coil component 1 mounted on the substrate, will be described.

As illustrated in FIG. 7, a space between the coil 30 and the first principal surface 13 in the height direction is defined as a side gap G1, and a space between the coil 30 and the second principal surface 14 in the height direction is defined as a side gap G2. Here, the first principal surface 13 serves as a mounting surface.

When the substrate having the multilayer coil component mounted thereon warps, stress is applied particularly to a region near an end portion of each outer electrode extending to the mounting surface, inside the element body of the multilayer coil component. When the side gap G1 decreases, the first principal surface 13 (mounting surface) and the coil conductor 32 become closer and the first principal surface 13 and the first cavity 51 on the coil conductor 32 also become closer. If the side gap G1 becomes too small, the first cavity 51 becomes closer to the region where stress applied is particularly high, and cracks may develop inside the element body, originating from the first cavity 51.

To reduce the occurrence of cracks associated with warpage of the substrate, a certain amount of side gap G1 is to be preferably maintained. Specifically, the side gap G1 is preferably greater than or equal to 43 μm, more preferably greater than or equal to 44 μm, and still more preferably greater than or equal to 46 μm. Thus by setting the lower limit of the side gap G1, the occurrence of cracks associated with warpage of the substrate can be prevented. Although the upper limit of the side gap G1 is not particularly limited, it may be less than or equal to 150 μm. Although the side gap G2 is not particularly limited, it may be greater than or equal to 43 μm and less than or equal to 150 μm (i.e., from 43 μm to 150 μm), as in the side gap G1.

As the size of the multilayer coil component decreases, the lower limit of the side gap G1 required also decreases. Therefore, in the multilayer coil component 1 with the side gap G1 satisfying the condition described above, the occurrence of cracks associated with warpage of the substrate can be more effectively prevented. For this, the size of the multilayer coil component 1 is preferably less than or equal to size 1608 and is more preferably, for example, size 1608, size 1005, size 0603, or size 0402.

Generally, in horizontally-wound multilayer inductors, there is much conductive paste, such as Ag paste, in the area where the land is formed. Since higher pressure is applied to the land than to the circumferential portion in the same layer during manufacture, the distance from the land to an adjacent coil conductor tends to be shorter than that from the circumferential portion in the same layer to the adjacent coil conductor.

Therefore, in the present embodiment as illustrated in FIG. 8, in adjacent coil conductors 32, a distance D1 between the land 35 and the circumferential portion 34 facing each other may be smaller than a distance D2 between two circumferential portions 34 facing each other. The distance D1 between the land 35 and the circumferential portion 34 facing each other, which is compared to the distance D2, is measured in the center of the land 35 in the line-width direction, in the LT cross-section passing through the center of the land 35. The distance D2 between two circumferential portions 34 facing each other, which is compared to the distance D1, is measured in the center of the circumferential portion 34 in the line-width direction, in the LT cross-section passing through the coil axis. In this case, two lands 35 facing each other, with the via conductor 33 therebetween, are each preferably provided with the second cavity 52 between the surface thereof to which the via conductor 33 is not connected and the insulating layer 31. Thus, for two lands 35 that are close to adjacent coil conductors 32, the second cavities 52 are provided on both surfaces to which the via conductors 33 are not connected. This can effectively further reduce stray capacitance.

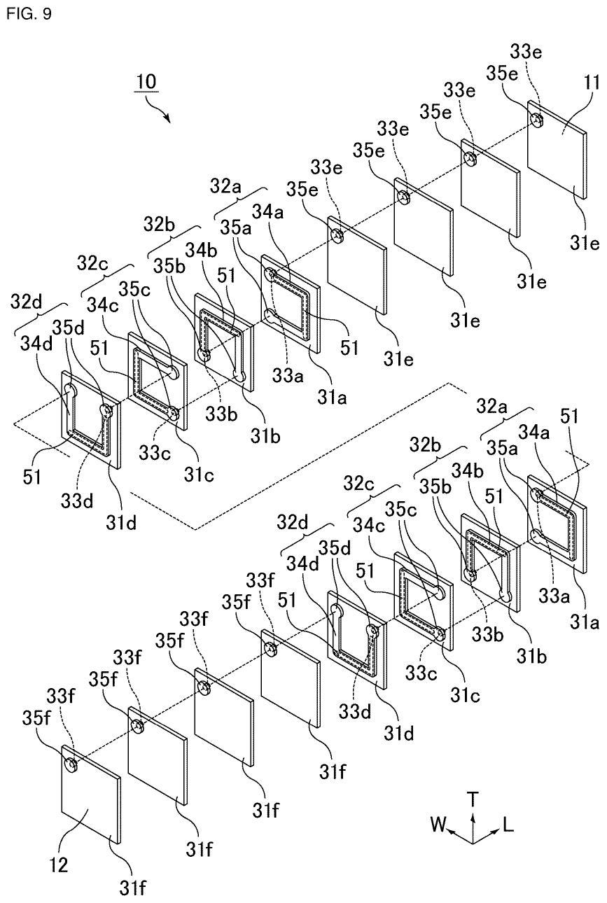

FIG. 9 is an exploded perspective view schematically illustrating another example of the multilayer body constituting the multilayer coil component illustrated in FIG. 1.

As illustrated in FIG. 9, the first cavity 51 may be provided between the first surface of only part of the circumferential portion 34 and the insulating layer 31. This makes it possible both to improve high-frequency characteristics by reducing stray capacitance using the first cavity 51 and to increase inductance by bringing the coil conductor 32 closer as much as possible to the insulating layer 31 (preferably made of a magnetic material here) in the region where the first cavity 51 is absent. By partially providing the first cavity 51, the strength of the element body can be made greater than by providing the first cavity 51 over the entire one surface of the circumferential portion 34 (see FIG. 2 and FIG. 7).

As illustrated in FIG. 9, the first cavity 51 may be extended from the vicinity of one land 35 to the middle of the circumferential portion 34.

An example of a method for manufacturing the multilayer coil components according to the present disclosure will now be described.

### <Step of Producing Magnetic Material>

First, Fe₂O₃, ZnO, CuO, and NiO are weighed to a predetermined ratio.

Next, these weighed materials, pure water, and the like are placed in a ball mill together with partially stabilized zirconia (PSZ) media, mixed, and pulverized. The mixing and pulverizing time is, for example, longer than or equal to four hours and shorter than or equal to eight hours.

The resulting material obtained by the pulverization is dried and then calcined. The calcination temperature is, for example, higher than or equal to 700° C. and lower than or equal to 800° C. (i.e., from 700° C. to 800° C.). The calcination time is, for example, longer than or equal to two hours and shorter than or equal to five hours.

A powdered magnetic material, more specifically, a powdered magnetic ferrite material, is thus produced.

The ferrite material is preferably a Ni—Cu—Zn ferrite material.

The Ni—Cu—Zn ferrite material preferably contains, with the total amount being 100 mol %, greater than or equal to 40 mol % and less than or equal to 49.5 mol % (i.e., from 40 mol % to 49.5 mol %) of Fe in terms of Fe₂O₃, greater than or equal to 2 mol % and less than or equal to 35 mol % (i.e., from 2 mol % to 35 mol %) of Zn in terms of ZnO, greater than or equal to 6 mol % and less than or equal to 13 mol % (i.e., from 6 mol % to 13 mol %) of Cu in terms of CuO, and greater than or equal to 10 mol % and less than or equal to 45 mol % (i.e., from 10 mol % to 45 mol %) of Ni in terms of NiO.

The Ni—Cu—Zn ferrite material may further contain an additive, such as Co, Bi, Sn, or Mn.

The Ni—Cu—Zn ferrite material may further contain unavoidable impurities.

### <Step of Producing Green Sheet>

First, a magnetic material, an organic binder such as polyvinyl butyral resin, an organic solvent such as ethanol or toluene, and a plasticizer are placed in a ball mill together with PSZ media, mixed, and pulverized to produce a slurry.

After the slurry is formed into a sheet with a predetermined thickness using a doctor blade method or the like, the sheet is punched into a predetermined shape to produce a green sheet. The thickness of the green sheet is, for example, greater than or equal to 20 μm and less than or equal to 30 μm (i.e., from 20 μm to 30 μm). The shape of the green sheet is, for example, rectangular.

As the material of the green sheet, a non-magnetic material, such as a borosilicate glass material, may be used instead of the magnetic material, or a mixture of the magnetic material and the non-magnetic material may be used.

### <Step of Forming Conductor Pattern>

First, via holes are formed by irradiating a predetermined area of the green sheet with a laser.

After a resin paste is applied to the surface of the green sheet by screen printing or the like, a conductive paste, such as an Ag paste, is applied to the surface of the green sheet by screen printing or the like while the via holes are being filled with the conductive paste. The resin paste is obtained by adding, to a solvent (such as isophorone), a resin (such as acryl resin) to be burned out during firing. The resin paste is applied to an area where cavities are to be formed. Thus, while a via conductor pattern is being formed in the via holes in the green sheet, a coil conductor pattern connected to the via conductor pattern is formed on the surface of the green sheet, with a cavity-forming resin pattern therebetween. Then, a resin paste may be applied onto the coil conductor pattern to further form a cavity-forming resin pattern. A coil sheet is thus produced by forming the coil conductor pattern, the via conductor pattern, and the cavity-forming resin pattern on the green sheet. A coil conductor pattern corresponding to the coil conductors 32 illustrated in FIG. 2 and a via conductor pattern corresponding to the via conductors 33 illustrated in FIG. 2 (excluding the via conductors 33e and 33f) are formed on the coil sheet. The cavity-forming resin pattern is substantially the same as the coil conductor pattern. The cavity-forming resin pattern preferably has a line width slightly smaller than the line width of the coil conductor pattern.

No resin paste may be applied to an area where second cavities 52 for land portions are to be formed. This is because even in this case, there is much conductive paste in this area and shrinkage of the conductive paste can form the second cavities 52. Separately from the coil sheet, a via sheet having thereon a via conductor pattern corresponding to the via conductors 33e and 33f illustrated in FIG. 2 and a land conductor pattern corresponding to the lands 35e and 35f illustrated in FIG. 2, is produced.

### <Step of Producing Multilayer Body Block>

A multilayer body block is produced by laminating the coil sheet and the via sheet in the lamination direction (length direction L) in the order corresponding to FIG. 2 and applying thermocompression bonding to the resulting laminate.

### <Step of Producing Multilayer Body and Coil>

First, individual chips are made by cutting the multilayer body block to a predetermined size using a dicer or the like.

Next, the individual chips are fired. The firing temperature is, for example, higher than or equal to 900° C. and lower than or equal to 920° C. (i.e., from 900° C. to 920° C.). The firing time is, for example, longer than or equal to two hours and shorter than or equal to four hours.

When the individual chips are fired, the green sheets of the coil sheet and the via sheet turn into insulating layers.

Also, when the individual chips are fired, the coil conductor pattern, the via conductor pattern, and the land conductor pattern turn into coil conductors, via conductors, and lands, respectively. As a result, a coil is produced, in which a plurality of coil conductors laminated together with the insulating layers are electrically connected, with the via conductors therebetween. When the cavity-forming resin pattern is burned out, the conductor pattern shrinks more than the green sheet to form cavities.

A multilayer body is thus produced, which is formed by laminating a plurality of insulating layers in the lamination direction and has a coil therein.

The multilayer body may be rounded by barrel finishing or the like at corners and ridges thereof.

### <Step of Forming Outer Electrode>

First, a conductive paste layer is formed by applying a conductive paste, such as a paste containing Ag and fritted glass, to each of the first end surface and the second end surface of the outer surface of the multilayer body to which the coil is extended.

Next, a base electrode for each outer electrode is formed by baking the conductive paste layer. The baking temperature is, for example, higher than or equal to 800° C. and lower than or equal to 820° C. (i.e., from 800° C. to 820° C.). The thickness of the base electrode is, for example, 5 μm.

Then, a Ni-plated electrode and a Sn-plated electrode are formed in sequence on the surface of the base electrode by electrolytic plating or the like. Thus, outer electrodes, each including the base electrode, the Ni-plated electrode, and the Sn-plated electrode in this order, are formed.

A multilayer coil component is thus manufactured.

Hereinafter, the results of verifying the amount of side gap that does not cause cracks inside the element body of the multilayer coil component, according to the present embodiment, will be described.

With the manufacturing method described above, 15 multilayer coil components with different side gaps G1 and G2 were prepared as samples, in which a first cavity was provided only between the insulating layer and the first surface of the circumferential portion of every coil conductor. All the multilayer coil components are of size 1608. The dimensions of 15 samples were measured and the average dimensions determined were as follows: the dimensions of the multilayer coil component including the outer electrodes were 1.530 mm, 0.822 mm, and 0.822 mm in the length direction L, the width direction W, and the height direction T, respectively, and the dimensions of the multilayer body having no outer electrodes thereon were 1.372 mm, 0.783 mm, and 0.783 mm, in the length direction L, the width direction W, and the height direction T, respectively.

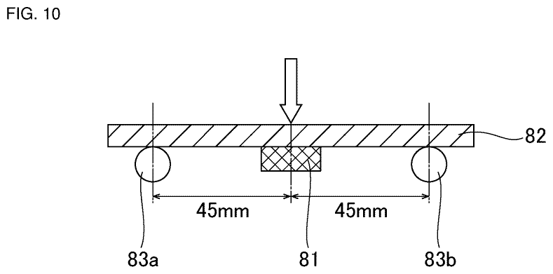

FIG. 10 schematically illustrates a test method for verifying the amount of side gap.

As illustrated in FIG. 10, first, a multilayer coil component 81 (sample) was mounted on a substrate 82, with a first principal surface thereof as the mounting surface.

The substrate 82 was supported by support portions 83a and 83b both at a distance of 45 mm from the center of the multilayer coil component 81 in the length direction, with the multilayer coil component 81 on the lower side of the substrate 82. Then, stress was applied to the center of the multilayer coil component 81 from the back side of the substrate 82 not having the multilayer coil component 81 thereon, until the amount of warpage of the substrate 82 reached 3 mm. This was followed by checking whether cracks had developed inside the element body of the multilayer coil component 81. Although 2 mm is practically sufficient as the amount of warpage, the test was performed, with the amount of warpage set to 3 mm, to allow more margin. The results are shown in Table 1 below.

TABLE 1

| | | | Cracks |
|---|---|---|---|
| Sample No. | G1 (μm) | G2 (μm) | Observed |
| 1 | 65.40 | 53.63 | No |
| 2 | 66.73 | 54.20 | No |
| 3 | 67.06 | 41.26 | No |
| 4 | 53.12 | 48.46 | No |
| 5 | 37.34 | 74.30 | Yes |
| 6 | 49.89 | 52.37 | No |
| 7 | 46.70 | 72.55 | No |
| 8 | 55.60 | 54.02 | No |
| 9 | 57.83 | 52.14 | No |
| 10 | 57.86 | 52.93 | No |
| 11 | 41.45 | 68.99 | Yes |
| 12 | 63.23 | 46.05 | No |
| 13 | 49.51 | 51.07 | No |
| 14 | 49.53 | 72.96 | No |
| 15 | 52.41 | 56.31 | No |

The results show that the side gap G1 is preferably greater than or equal to 43 μm, more preferably greater than or equal to 44 μm, and still more preferably greater than or equal to 46 μm.

The following is disclosed in the present specification.

<1> A multilayer coil component includes a multilayer body formed by laminating a plurality of insulating layers, the multilayer body having a coil therein; and a first outer electrode and a second outer electrode electrically connected to the coil. The coil is formed by electrically connecting a plurality of coil conductors laminated together with the insulating layers, with a via conductor passing through the insulating layers therebetween. The coil conductors each include a circumferential portion and a land connected to the via conductor. The multilayer body has a first end surface and a second end surface facing each other in a length direction, a first principal surface and a second principal surface facing each other in a height direction orthogonal to the length direction, and a first side surface and a second side surface facing each other in a width direction orthogonal to the length direction and the height direction. A coil axis of the coil is parallel to the first principal surface. The coil conductors each have a first surface facing in a first direction parallel to the coil axis and a second surface facing in a direction opposite the first direction. The circumferential portion of at least one of the coil conductors is provided with a first cavity only between the first surface thereof and the insulating layer.

<2> In the multilayer coil component according to <1>, the circumferential portion of every coil conductor is provided with the first cavity only between the first surface thereof and the insulating layer.

<3> In the multilayer coil component according to <1>, the circumferential portion of at least one of the coil conductors is provided with the first cavity only between the first surface or second surface thereof and the insulating layer. Some of the at least one of the coil conductors are each provided with the first cavity only between the first surface of the circumferential portion thereof and the insulating layer. The remaining coil conductors are each provided with the first cavity only between the second surface of the circumferential portion thereof and the insulating layer.

<4> In the multilayer coil component according to <3>, the circumferential portion of every coil conductor is provided with the first cavity only between the first surface or second surface thereof and the insulating layer. Some of the coil conductors are each provided with the first cavity only between the first surface of the circumferential portion thereof and the insulating layer. Every remaining coil conductor is provided with the first cavity only between the second surface of the circumferential portion thereof and the insulating layer.

<5> In the multilayer coil component according to any one of <1> to <4>, a width of the first cavity is smaller than a width of the circumferential portion.

<6> In the multilayer coil component according to any one of <1> to <5>, a width of the land is greater than a width of the circumferential portion. The land of the coil conductor having the first cavity thereon is provided with a second cavity between a surface thereof to which the via conductor is not connected and the insulating layer. The second cavity is thicker than the first cavity.

<7> In the multilayer coil component according to any one of <1> to <6>, the first cavity is provided between the first surface of only part of the circumferential portion and the insulating layer.

<8> In the multilayer coil component according to any one of <1> to <7>, in adjacent ones of the coil conductors, a distance between the land and the circumferential portion facing each other is smaller than a distance between two circumferential portions facing each other. Two lands facing each other, with the via conductor therebetween, are each provided with a second cavity between a surface thereof to which the via conductor is not connected and the insulating layer.

<9> In the multilayer coil component according to any one of <1> to <8>, a thickness of the first cavity is greater than or equal to 1 μm and less than or equal to 15 μm (i.e., from 1 μm to 15 μm).

<10> In the multilayer coil component according to any one of <1> to <9>, the first principal surface is a mounting surface. A space between the coil and the first principal surface in the height direction is greater than or equal to 43 μm.

What is claimed is:

1. A multilayer coil component comprising:
a multilayer body including a plurality of insulating layers laminated together, the multilayer body having a coil therein; and
a first outer electrode and a second outer electrode electrically connected to the coil,
wherein the coil is configured by electrically connecting a plurality of coil conductors laminated together with the insulating layers, with a via conductor passing through the insulating layers therebetween;
the coil conductors each include a circumferential portion and a land connected to the via conductor;
the multilayer body has a first end surface and a second end surface facing each other in a length direction, a first principal surface and a second principal surface facing each other in a height direction orthogonal to the length direction, and a first side surface and a second side surface facing each other in a width direction orthogonal to the length direction and the height direction;
a coil axis of the coil is parallel to the first principal surface;
the coil conductors each have a first surface facing in a first direction parallel to the coil axis and a second surface facing in a direction opposite the first direction; and
the circumferential portion of at least one of the coil conductors includes a first cavity only between the first surface thereof and the insulating layer.

2. The multilayer coil component according to claim 1, wherein
the circumferential portion of every coil conductor includes the first cavity only between the first surface thereof and the insulating layer.

3. The multilayer coil component according to claim 1, wherein
the circumferential portion of at least one of the coil conductors includes the first cavity only between the first surface or second surface thereof and the insulating layer;
some of the at least one of the coil conductors each includes the first cavity only between the first surface of the circumferential portion thereof and the insulating layer; and
the remaining coil conductors each includes the first cavity only between the second surface of the circumferential portion thereof and the insulating layer.

4. The multilayer coil component according to claim 3, wherein
the circumferential portion of every coil conductor includes the first cavity only between the first surface or second surface thereof and the insulating layer;
some of the coil conductors each includes the first cavity only between the first surface of the circumferential portion thereof and the insulating layer; and
every remaining coil conductor includes the first cavity only between the second surface of the circumferential portion thereof and the insulating layer.

5. The multilayer coil component according to claim 1, wherein
a width of the first cavity is smaller than a width of the circumferential portion.

6. The multilayer coil component according to claim 1, wherein
a width of the land is greater than a width of the circumferential portion;
the land of the coil conductor having the first cavity thereon includes a second cavity between a surface thereof to which the via conductor is not connected and the insulating layer; and
the second cavity is thicker than the first cavity.

7. The multilayer coil component according to claim 1, wherein
the first cavity is between the first surface of only part of the circumferential portion and the insulating layer.

8. The multilayer coil component according to claim 1, wherein
in adjacent ones of the coil conductors, a distance between the land and the circumferential portion facing each other is smaller than a distance between two circumferential portions facing each other; and
two lands facing each other, with the via conductor therebetween, each includes a second cavity between a surface thereof to which the via conductor is not connected and the insulating layer.

9. The multilayer coil component according to claim 1, wherein
a thickness of the first cavity is from 1 μm to 15 μm.

10. The multilayer coil component according to claim 1, wherein
the first principal surface is a mounting surface;
a space between the coil and the first principal surface in the height direction is greater than or equal to 43 μm.

11. The multilayer coil component according to claim 2, wherein
a width of the first cavity is smaller than a width of the circumferential portion.

12. The multilayer coil component according to claim 3, wherein
a width of the first cavity is smaller than a width of the circumferential portion.

13. The multilayer coil component according to claim 2, wherein
a width of the land is greater than a width of the circumferential portion;
the land of the coil conductor having the first cavity thereon includes a second cavity between a surface thereof to which the via conductor is not connected and the insulating layer; and
the second cavity is thicker than the first cavity.

14. The multilayer coil component according to claim 3, wherein
a width of the land is greater than a width of the circumferential portion;
the land of the coil conductor having the first cavity thereon includes a second cavity between a surface thereof to which the via conductor is not connected and the insulating layer; and
the second cavity is thicker than the first cavity.

15. The multilayer coil component according to claim 2, wherein
the first cavity is between the first surface of only part of the circumferential portion and the insulating layer.

16. The multilayer coil component according to claim 3, wherein
the first cavity is between the first surface of only part of the circumferential portion and the insulating layer.

17. The multilayer coil component according to claim 2, wherein
in adjacent ones of the coil conductors, a distance between the land and the circumferential portion facing each other is smaller than a distance between two circumferential portions facing each other; and
two lands facing each other, with the via conductor therebetween, each includes a second cavity between a surface thereof to which the via conductor is not connected and the insulating layer.

18. The multilayer coil component according to claim 3, wherein
in adjacent ones of the coil conductors, a distance between the land and the circumferential portion facing each other is smaller than a distance between two circumferential portions facing each other; and
two lands facing each other, with the via conductor therebetween, each includes a second cavity between a surface thereof to which the via conductor is not connected and the insulating layer.

19. The multilayer coil component according to claim 2, wherein
a thickness of the first cavity is from 1 μm to 15 μm.

20. The multilayer coil component according to claim 2, wherein
the first principal surface is a mounting surface;
a space between the coil and the first principal surface in the height direction is greater than or equal to 43 μm.
